(19) United States
(12) Patent Application Publication
(10) Pub. No.: US 2010/0291515 A1
(43) Pub. Date: Nov. 18, 2010

(54) Regulating Food and Beverage Intake

(75) Inventors: Michael D. Pinnisi, Ithaca, NY (US); Brian Wansink, Ithaca, NY (US)

Correspondence Address: FISH & RICHARDSON P.C., P.O. BOX 1022, MINNEAPOLIS, MN, 55440-1022, US

(73) Assignee: MINDLESS PRODUCTS LLC, Ithaca, NY (US)

(21) Appl. No.: 12/777,737

(22) Filed: May 11, 2010

Related U.S. Application Data
(60) Provisional application No. 61/177,577, filed on May 12, 2009.

(51) Int. Cl. G09B 19/00; A47G 19/00

(52) U.S. Cl. 434/127; 220/574

(57) ABSTRACT

A method for reducing food intake, the method including providing tableware having one or more characteristics designed to influence the subjective perception of the amount of food or beverage to be consumed by an individual. A device for influencing the subjective perception of food or beverage to be consumed by an individual, the device including tableware having one or more characteristics which when compared to a portion of food or beverage combined with the tableware alters the subjective perception of the quantity of food or beverage to be consumed. A method of regulating food intake, the method comprising regulating one or more characteristics of an environment within which an individual consumes food to influence the subjective perception of the amount of food or beverage to be consumed by an individual, the one or more characteristics comprising one or more of color, lighting, sound, and temperature.

### CROSS-REFERENCE TO RELATED APPLICATION

This application claims the benefit of U.S. Provisional Application Ser. No. 61/177,577, filed May 12, 2009 and titled REGULATING FOOD AND BEVERAGE INTAKE, which is incorporated by reference in its entirety.

### TECHNICAL FIELD

This disclosure is generally related to influencing food consumption through the design of tableware.

### BACKGROUND

Many factors contribute to the amount of food that an individual eats in any one sitting. Individuals employ different criteria at different times to decide whether they have become physically satiated or otherwise satisfied with the amount of food consumed.

When attempting to control weight gain or to conduct weight loss, an individual may attempt to reduce the amount of food consumed. This reduction sometimes is achieved by portion control methods of weighing or volumetrically measuring the food to be consumed, using the data so obtained to calculate desired amounts or calorie counts. Regulation of food consumption more often is achieved by simple visual estimation of the amount of the food to be eaten, with the eater subjectively deciding whether a given amount of food is adequate as a portion or meal.

Methods of measurement and estimation vary greatly in difficulty to conduct and in accuracy. Direct measurement is accurate but messy and time consuming and thus frequently avoided. More often, the eater relies upon visual estimation of the amount of food in a serving. Such visual estimation is very quick and easy to perform, but its efficacy depends greatly upon the accuracy with which a particular individual is able to quantify a food serving.

The above-described methods to reduce food consumption employ conscious intention and action in order to reduce the amount of food consumed. Use of such methods in order to control or lose weight requires degrees of diligence, execution, will power, toleration of deprivation, and perseverance in order to obtain the desired objectives.

### SUMMARY

An improvement over the above-described methods reduces food consumption without need for careful action and without perception of deprivation. This accomplishes reduced calorie consumption without reliance upon conscious sustained action and tolerance of discomfort.

Such results can be accomplished by manipulation of the visual estimation method through regulation of cues that affect the perception of food volume. Visual estimation is inherently subjective, and many psychological factors play a very large part in the operation and accuracy of the process.

A person's sense of satisfaction with any given objective amount of food is influenced by the eater's subjective perception of the amount of food. This subjective sense of satisfaction is somewhat independent of the objective mass or volume or calories consumed.

The effect of enhanced subjective satisfaction can be achieved by the employment of visual cues to increase the perception of the amount of the food consumed. Any given amount of food can be made to appear larger or smaller based upon visual cues such as the size, design, color, and other criteria of the plate upon which it is served. This effect also can be achieved by other factors such as the weight of the tableware. This effect also can be achieved by regulation of eating environment conditions such as color, lighting, sound, temperature, and other criteria.

By employment of cues intended to increase the subjective perception of the amount of food consumed, an eater can be influenced to reduce food consumption without the effort and execution of direct measurement methods or the perseverance and will power required for their sustained conduct and effect.

In one general aspect, a device for influencing the subjective perception of food or beverage to be consumed by an individual includes one or more items of tableware having one or more characteristics which when compared to a portion of food or beverage combined with the tableware alters the subjective perception of the quantity of food or beverage to be consumed.

Implementations can include one or more of the following features. For example, the tableware is one or more of a dinner plate, a soup bowl, a glass, and a utensil. The one or more characteristics is a size of the tableware and the subjective perception of the quantity of food or beverage is altered by regulation of the size of the tableware. The one or more characteristics is one of a graphic design, color, shape, or weight of the tableware and the subjective perception of the quantity of food or beverage is altered based on the characteristic. The dinner plate can have a diameter of about 9 inches to about 11 inches, the soup bowl is less than about 12 ounces, the glass is less than about 10 ounces, and the utensil is less than about 2 ounces. The graphic design characteristics include verge lines, rim designs, contrasting colors, textures, and finishes.

In another general aspect, a method of reducing food intake includes providing tableware having one or more characteristics designed to influence the subjective perception of the amount of food or beverage to be consumed by an individual.

Implementations can include one or more of the following features. For example, providing tableware includes providing one or more of a dinner plate, a soup bowl, a glass, and a utensil. The one or more characteristics can be a size of the tableware and the method further includes regulating the size of the tableware to affect the individual's perception of the amount of food or beverage contained in the tableware. The one or more characteristics can also include one of a graphic design, color, shape, or weight of the tableware and the method further includes regulating one of the graphic design, color, shape, or weight of the tableware to affect the individual's perception of the amount of food or beverage contained in the tableware. The dinner plate can have a diameter of about 9 inches to about 11 inches, the soup bowl is less than about 12 ounces, the glass is less than about 10 ounces, and the utensil is less than about 2 ounces. The graphic design characteristics include verge lines, rim designs, contrasting colors, textures, and finishes.

In another general aspect, a dishware system includes a first plate having a first outer diameter, a second plate having a second outer diameter, a ratio of the second outer diameter to the first outer diameter being about three-to-four, a third plate having a third outer diameter, a ratio of the third outer diameter to the first outer diameter being about two-to-three, and a first bowl having a fourth outer diameter, a ratio of the fourth outer diameter to the first outer diameter being about two-to-three, wherein the first, second, third, and fourth outer diameters being proportionally sized to regulate the amount of food consumed by a user of the dishware system.

Implementations can include one or more of the following features. For example, the food intake reduction is in the range of about ten to thirty percent. The first outer diameter is within a range of about nine inches to about eleven inches.

The dishware system can include a first beverage container having a first height, a fifth outer diameter, and a first volume, a ratio of the first height to the fifth outer diameter being about two to one and the first volume being in a range of about eight to about ten ounces. The dishware system can further include a first beverage container having a first height, a fifth outer diameter, and a first volume, a ratio of the first height to the fifth outer diameter being about two to one and the first volume being in a range of about eight to about ten ounces. The dishware system can include a second beverage container having a second height, a sixth outer diameter, and a second volume, a ratio of the second height to the sixth outer diameter being about two to one and the second volume being in a range of about six ounces to about eight ounces. The dishware system can also include a placemat comprising a color that contrasts with a color of the first plate, and a set of flatware comprising a fork, a knife, and a spoon, each of the fork, knife, and spoon reduced in size proportionally to the size of the first plate. The size of one or more of the first plate, second plate, third plate, or first bowl is proportionally increased to induce a user to consume larger portions of food or proportionally decreased to induce the user to consume smaller portions of food. The diameter of one or more of the first plate, second plate, third plate, or first bowl is proportionally increased or decreased. A defined target area for receiving food in one or more of the first plate, second plate, third plate, or first bowl is proportionally increased to induce a user to consume larger portions of food or proportionally decreased to induce the user to consume smaller portions of food.

In another general aspect, a method of regulating food intake includes proportionally sizing items in a table setting, the items including a first plate, a first bowl, a first beverage container, and a piece of flatware, such that a user of the table setting is induced, based on the proportionality of the items in the table setting, to consume larger portions of food or smaller portions of food.

Implementations can include one or more of the following features. For example, the table setting further includes a placemat, the placemat having a color that contrasts with a color of the first plate, the contrasting colors configured to affect the amount of food the user consumes. The first plate has a first outer diameter and the table setting further includes a second plate having a second outer diameter, the ratio of the second outer diameter to the first outer diameter being about three-to-four, and a third plate having a third outer diameter, the ratio of the third outer diameter to the first outer diameter being about two-to-three.

In another general aspect, a proportionally-sized set of dishware that aids in the regulation of food intake includes a first plate having a first outer diameter, a planar region defined in a center region of the first plate, the planar region defining a target area for receiving food, and a rim area between the planar region and an edge of the first plate, a bowl having a second outer diameter and defining a second target area for receiving food, a ratio of the second outer diameter to the first outer diameter being about two-to-three, a first beverage container having a height and a third outer diameter, a ratio of the height to the third outer diameter being about two to one, and a utensil defining a food receiving area, wherein the first plate, the bowl, the first beverage container and the utensil are proportionally sized with respect to one another to increase or decrease the amount of food consumed by a user by affecting the user's perception of the amount of food or beverage present.

Implementations can include one or more of the following features. For example, the first plate further defines a verge line between the planar region and the rim, the verge line cooperating with the planar region and the rim to further delineate the target area for receiving food and the edge of the first plate. The dishware further includes a placement having a color that is different than a color of the first plate in order to enhance the user's perception of the food present on the first plate. One or more of the first plate, bowl, first beverage container, and utensil have one or more characteristics which when compared to a portion of food or beverage combined with the one or more of the first plate, bowl, beverage container and utensil alters the subjective perception of the quantity of food or beverage to be consumed. One or more of characteristics is one or more of a size, graphic design, color, shape, or weight. The graphic design characteristics include one or more of verge lines, rim designs, contrasting color, textures, and finishes.

In another general aspect, a method of regulating food intake includes regulating one or more characteristics of an environment within which an individual consumes food to influence the subjective perception of the amount of food or beverage to be consumed by an individual, the one or more characteristics comprising one or more of color, lighting, sound, and temperature.

### DESCRIPTION OF DRAWINGS

FIG. 1 is a perspective view of various presentations of food portions on different sized plates.

FIG. 2A is a perspective and side view of various plate designs.

FIG. 2B is a perspective view of a combination of plates and placemats.

FIG. 3 is a set of perspective view of glassware designs.

FIG. 4 is a perspective view of a set of proportionally-sized dishware.

Like reference symbols in the various drawings indicate like elements.

### DETAILED DESCRIPTION

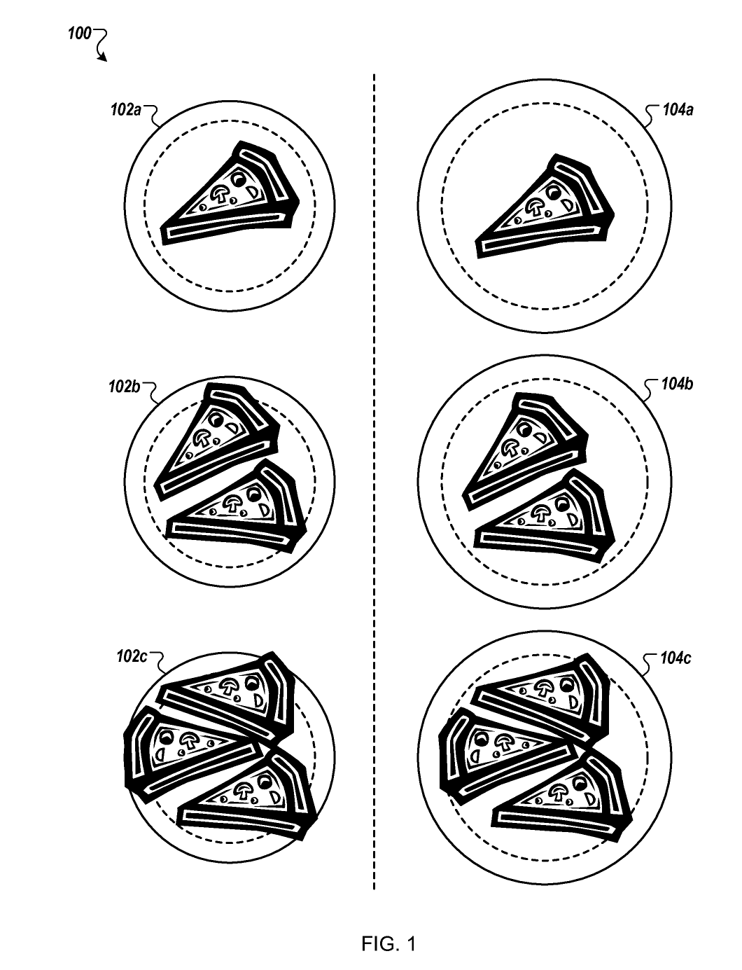

FIG. 1 is a diagram 100 illustrating comparative food portions on different sizes of plates. A first column includes a series of small diameter plates 102a, 102b, and 102c, while a second column includes a series of large diameter plates 104a, 104b, 104c. The large diameter plates 104a-c, for example, may be about twenty percent larger than the small diameter plates 102a-c (e.g., representing a twelve inch dinner plate versus a ten inch dinner plate). The size of a plate may visually suggest a portion size to an individual serving food due to the proportionality of the food in relation to the plate (e.g., a larger plate has more surface area to hold more food).

Each of plates 102a-c, 104a-c contains a portion of pizza. A first set of plates 102a, 104a each include a single slice of pizza. The slice of pizza covers a larger percentage of the surface area of the small diameter plate 102a. This causes the slice of pizza to appear larger than the same slice of pizza displayed upon the large diameter plate 104a. Therefore, an individual receiving the slice of pizza upon the small diameter plate 102a may be more likely to consider the single slice of pizza as being an adequate portion than an individual receiving the same slice of pizza upon the large diameter plate 104a.

In comparing a second set of plates 102b, 104b which each hold two slices of pizza, the small diameter plate 102b could be considered to appear “full”, while relatively considerable space is available upon the large diameter plate 104b. This may serve as a visual cue that the serving size of two pieces upon the small diameter plate 102b is an adequate serving portion. An individual eating from the large diameter plate 104b, on the other hand, may be more likely to select an additional slice to fill the remaining area of the large diameter plate 104b.

Three slices of pizza are arranged on each of a third set of plates 102c, 104c. The small diameter plate 102c is crowded and overflowing, while the large diameter plate 104c comfortably contains the three slices well within the boundaries of its diameter. This may serve as a visual cue that the serving size of three slices of pizza upon the large diameter plate 104c is an adequate serving portion. Because individuals typically serve larger portions on larger plates, and individuals typically eat the majority of the food upon the plate, selecting the large diameter plate 104c may lead an individual to over-consumption. If the individual desires to reduce calorie intake, on the other hand, the person may opt to eat from the small diameter plate 102c.

The actual size of the small diameter plates 102a-c may also contribute to whether or not a person is likely to select a smaller quantity of food. For example, plates with diameters anywhere between nine and twelve inches are generally considered an appropriate size for a dinner plate. Within that range, the total surface area of the plate nearly doubles as the diameter increases from nine to twelve inches. Use of a plate toward the smaller end of the range would cause a perception of a larger portion without conflicting with the user's sense that an appropriate plate is being used. However, if a person with such perception were to be handed, for example, an eight-inch plate, that same individual would be more apt to refill that plate because he or she would consider the plate to be too small to provide an adequate amount of food for the meal.

These effects are not limited to dinner plates. Similarly, the size of a salad plate, bread and butter plate, desert plate, cereal bowl, salad bowl, or pasta bowl, in some examples, can have an affect on portion control by altering the perception the person has of the quantity of food within the container. For example, three ounces of pasta may be heaped into a six inch diameter bowl, while the same amount of pasta may barely cover the bottom of a nine inch diameter bowl.

Further, factors other than size can also contribute significantly to perception of the amount of food in a given plate or bowl. Other factors include, for example, the topography, density, mass, material, color, design, and finish of the plate or bowl.

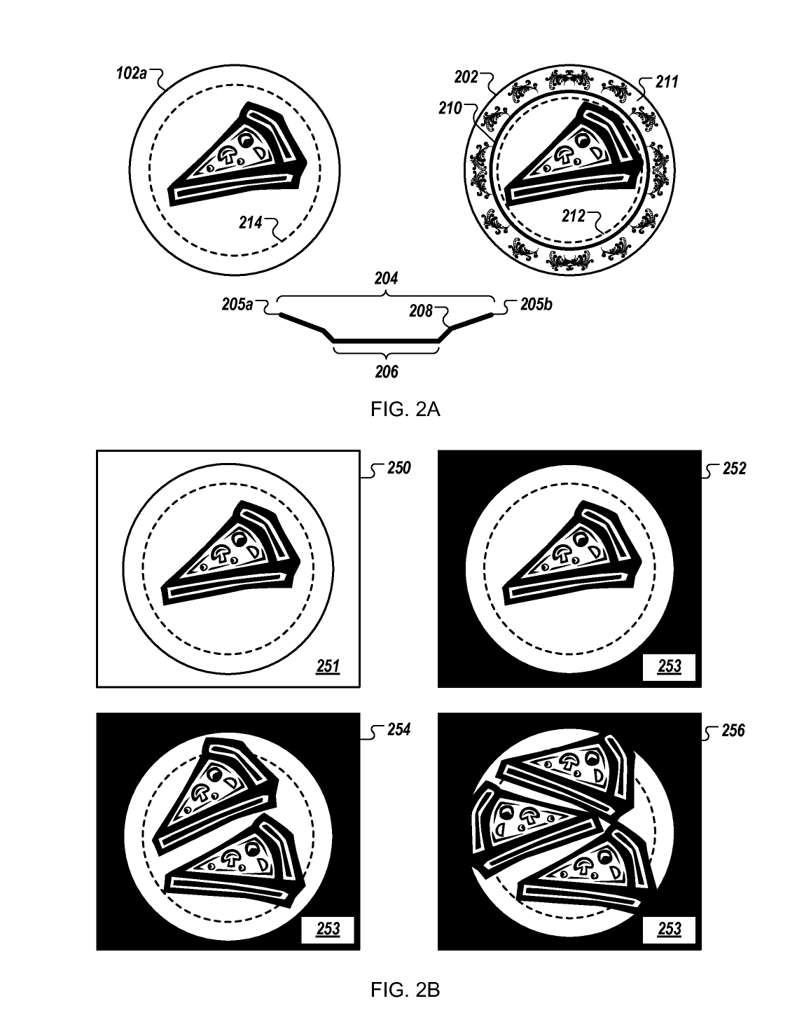

FIG. 2A illustrates various plate design options that may influence the amount of food consumed by an individual. In this example, the simple plate design of the small diameter plate 102a is compared to a decorative plate 202. The two plates 102a, 202 have the same outer diameter. Outer diameter, however, is just one measurement associated with the sizing dimensions of a plate. A typical plate can have an outer diameter 204 which reaches from edge 205a to edge 205b, a well diameter 206 which defines the planar region in the center of the plate, and a verge 208 which marks the beginning of the rim of the plate. The rim of the plate extends from the verge 208 to the outer edges 205a, 205b. The verge 208 of a given plate may be defined, in some examples, by a raised edge, a distinctly marked line (e.g., differing in color from the surrounding plate area), or the beginning of a patterned region along the rim of the plate.

The decorative plate 202 has a well-defined verge line 210 and a patterned rim area 211. A dotted line 212 is illustrated to represent the well area of the decorative plate 202. The small diameter plate 102a, in contrast, may be considered to be a simple plate of uniform color (e.g., white, off-white, etc.). A dotted line 214 represents the well area of the small diameter plate 102a. The well area bounded by the line 214 of the small diameter plate 102a is larger than the well area bounded by the line 212 of the decorative plate 202. Also, the verge line 210 and the patterned rim area 211 of the decorative plate 202 may serve to define a target area (e.g., the well area within the dotted line 212) for food to be served. The definition of a target area may discourage the person from adding food outside of the well area of the plate because it would encroach upon the decorative rim of the plate.

Although the small diameter plate 102a and the decorative plate 202 are essentially the same size, a person may be more apt to serve larger portions onto the small diameter plate 102a than the decorative plate 202. For example, an individual may find it less visually appealing to overlap the verge line or the rim pattern of the decorative plate 202 with food. The food served upon the decorative plate 202 (e.g., the slice of pizza as illustrated in FIG. 2) may also appear to be larger than the same food served upon the small diameter plate 102a due to the visual contrast of the food in relation to the verge line and/or the decorative rim pattern.

Other visual cues affect the appearance of food upon a given plate and therefore influence an individual's choice of how much of that food to consume. For example, high contrast between the color of the food being served and the color of the plate, or of the design upon the rim of the plate, increases the perception of the size of the portion. For example, a serving of mashed potatoes would appear larger on a dark plate.

In addition, the surroundings of the tableware also affect the perception of the portion size upon the plate. For example, as illustrated in FIG. 2B, a place setting 250 includes plate 102a holding a single slice of pizza positioned over a similarly-colored placemat 250, while a place setting 252 includes plate 102a holding a single slice of pizza positioned over a contrasting-colored placemat 253. The contrasting-colored placement 253 used in place setting 252 acts to enhance the perception of the target area (e.g., the plate) or to enhance the appearance of the food upon the plate 102a by providing another level of visual contrast.

The contrasting-colored placemat 253 may also be used to encourage a user to select a smaller portion. For example, as illustrated in place setting 254, when a second slice of pizza is introduced to the same plate 102a, the contrast of the light rim upon the dark placemat 253 may be diminished because a larger portion of the rim area is covered by the food. When adding a third slice of pizza to the plate 102a, as shown in place setting 256, a portion of the rim is covered by food and the contrast is further diminished. Other background elements of contrasting color, such as a charger or tablecloth, may be used rather than a placemat to introduce this visual contrast.

Although described in relation to plates, one or more of these factors may also contribute to the selection of a bowl (e.g., soup, salad, pasta, or cereal), serving bowl, flatware (e.g., fork, spoon, or knife), or serving utensils (e.g., serving spoon, ladle, etc.) that may positively affect limiting food intake. For example, a portable meal container, such as a covered plate, bowl, or sectioned dish, may be designed using the factors described above for portioning and transporting leftovers to work for lunch.

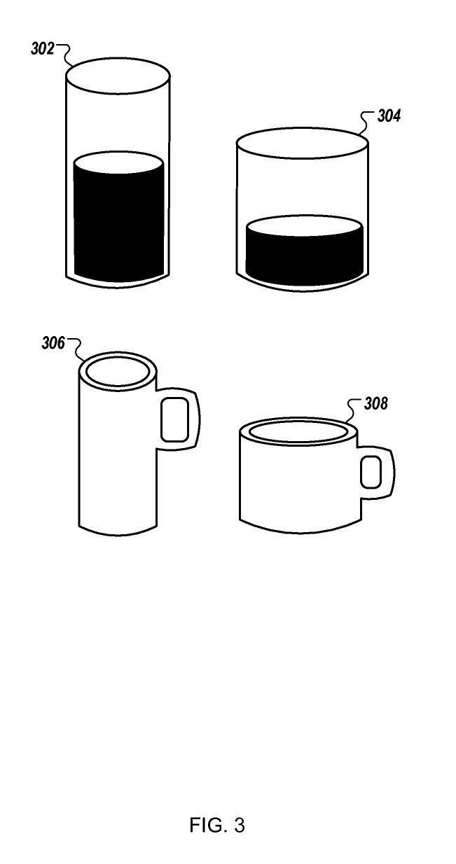

FIG. 3 illustrates glassware design options which may affect food intake and portion control. The human eye tends to place a greater emphasis on height rather than width. Thus, in general, a quantity of liquid added to a wide container appears to be smaller than the same quantity of liquid added to a narrow container. When pouring into a short, wide glass, a person may have the perception of serving a smaller quantity of beverage than when pouring the same amount into a tall, narrow glass. In this manner, a person may tend to pour a larger quantity of liquid into the short, wide glass than into the tall, narrow glass.

Referring to FIG. 3, a tall glass 302 has a height to diameter ratio of approximately two to one. A short glass 304 has a height to diameter ratio of approximately one to one. As illustrated, each glass 302, 304 contains approximately the same quantity of liquid. However, the tall glass 302 appears to be more than half full, while the short glass 304 appears to be less than half full. Thus, an individual may perceive the tall glass 302 as containing a larger portion of beverage than the short glass 304, and therefore, the individual may estimate upon visual inspection, for example, that a tall, slender eight ounce glass can hold the same volume of liquid as a shorter, wider ten ounce glass.

This perception of taller glasses having a greater capacity may be used to an advantage in terms of reducing an individual's intake of certain beverages. In some circumstances, a person may prefer to consume a smaller quantity of beverage. For example, when serving a high-calorie or high-caffeine beverage, the user may prefer to serve a smaller quantity. If the user has tall slender glassware available, he or she may use the tall glasses to encourage portion control. As an additional example, a family may use tall slender glasses to control juice portions at breakfast. Further, a restaurateur may prefer to serve beverages in a tall slender glass so that the customer perceives a greater value for the beverage consumed and the restaurateur can recognize a larger profit margin. For service of water, a different glass may be selected.

Referring again to FIG. 3, a tall mug 306 can have a height to diameter ratio of approximately two to one while a short mug 308 has a height to diameter ratio of approximately one to one. A small reduction in total volume, along with a perceived equivalence in total volume between the tall mug 306 and the short mug 308 (e.g., a standard shaped coffee vessel) can equate to fewer calories and/or lower caffeine intake without an effort to modify habits beyond keeping the tall mug 306 in the cabinet rather than the short mug 308. In some embodiments, a reduction of total volumetric capacity of approximately twenty percent, along with a modification of the height-to-weight ratio to approximately two to one, can be achieved while the individual perceives approximate volumetric equivalence between the two pieces of glassware.

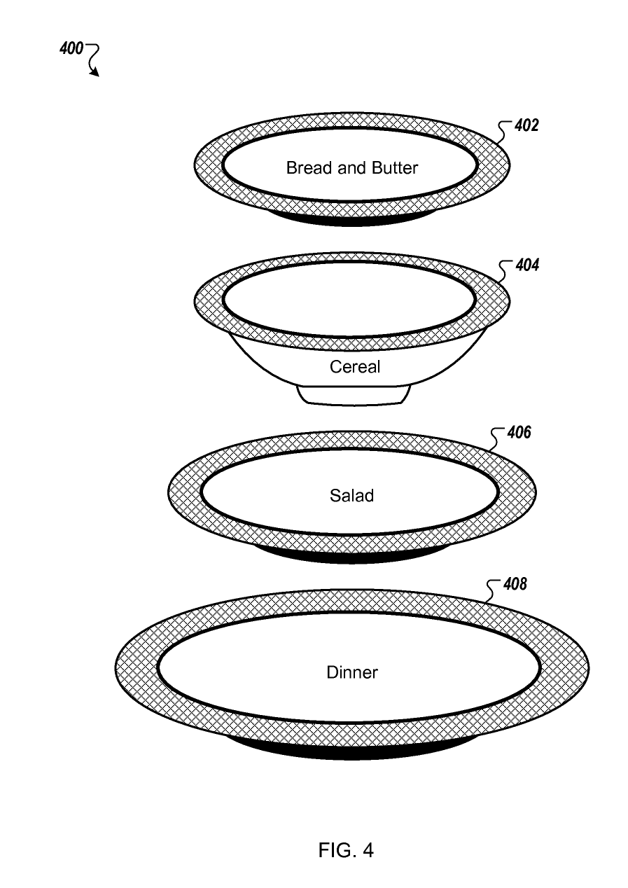

FIG. 4 illustrates a set or grouping of proportionally sized dishware 400 designed to aid in food intake or portion control. A bread and butter plate 402, a cereal/soup bowl 404, a salad plate 406, and dinner plate 408 may be elements within a standard place setting of dishware 400. The size, shape, or design of the dishware 400 may contribute to an individual's perception of portion size. For example, by proportionally adjusting the sizes of the individual elements 402, 404, 406, or 408 of the dishware 400, an individual may be induced to serve smaller portions of food while continuing to perceive the portions as adequately sized.

Use of a disproportional item could serve as a negative visual cue. For example, if a small plate of perhaps ten inch diameter is employed with large bowls and glasses, it would be made to appear smaller by comparison. This may cause the user to reject the small plate, or to take second helpings on the plate, which would not occur if all tableware had been reduced proportionally to the small plate.

In addition, one or more of the elements 402, 404, 406, or 408 may be proportionally adjusted to encourage larger relative portions. For example, the size of the salad plate 406 may be increased proportionally to the size of the dinner plate 408 to encourage the individual to select larger portions of salad and smaller portions of entrée items. In another example, the size of an element of the dishware 400 may be proportionally increased or decreased without a noticeable difference in diameter in relation to other dishware elements. For example, the size of the salad plate 406 may be increased by increasing the depth of the well of the salad plate 406.

The dishware 400 may be packaged for sale as a unit to provide an individual with a proportionally sized set of dishware which can aide in regulating eating behavior. For example, the dishware 400, the tall glass 302 (as shown in FIG. 3), and the tall mug 306 may be packaged as a dishware set. In some embodiments, proportionally adjusted flatware may additionally be provided within the dishware set. Other combinations are of course possible, to achieve different intended effects upon perception.

As illustrated in FIG. 4, the salad plate 406 is approximately three quarters the diameter of the dinner plate 408, while both the cereal/soup bowl 404 and the bread and butter plate 402 are approximately two-thirds the diameter of the dinner plate 408. The dinner plate 408 may be designed to reduce the overall portion size a person selects in comparison to a standard (e.g., eleven or twelve inch diameter) dinner plate. In one example, the dinner plate 408 may be about nine inches in diameter, while the salad plate 406 may be about seven inches in diameter and the cereal/soup bowl 404 and bread and butter plate 402 may be about six inches in diameter.

Table 1 illustrates an exemplary range of standard-sized dishware available within stores in comparison to a smaller-sized range of the dishware which may be substituted to reduce food consumption without an individual recognizing that portions have been reduced.

TABLE 1
reduced dishware sizes for portion control

| | | | Reduced Size for | |
|---|---|---|---|---|
| | Standard Size Range | | Portion Control | |
| Glass | 12-20 | ounces | ≦10 | ounces |
| Mug | 10-16 | ounces | ≦8 | ounces |
| Dinner Plate | ≧11 | inch diameter | 9-11 | inch diameter |
| Salad Plate | 7-9 | inch diameter | ≦7 | inch diameter |
| Bread Plate | 6-7 | inch diameter | ≦6 | inch diameter |
| Cereal/Soup Bowl | 16-24 | ounces | ≦12 | ounces |

| | | | |
|---|---|---|---|
| Serving Spoon | Greater than 3 ounces | ≦2 | ounces |

For example, a two-inch reduction in the diameter of a dinner plate has been shown to induce users to eat an average of twenty-two percent fewer calories without a perception of reduced intake.

Other dishware elements may similarly be reduced in proportion, such as, for example, soup spoons, forks, ice cream bowls, serving forks, or pasta bowls.

Individual dishware elements may also be sized to provide a target area for the food equating to approximately a desired serving portion. For example, an ice cream bowl may be proportioned to encourage a user visually to serve an approximate three ounce serving. A proportionally-sized ice cream scoop may be bundled with a proportionally sized ice cream bowl or bowl set to encourage a smaller serving. The ice cream bowl may have a well area, external diameter, verge line, rim design, and/or other visual cues to encourage a user to serve the ice cream within a defined target area of the ice cream bowl. In another example, a salad serving bowl, individual salad bowls and salad tongs may be proportionally designed and, in some embodiments, packaged as a unit for sale to encourage the service (and therefore consumption) of large portions of salads.

While this description contains many specifics, these should not be construed as limitations on the scope of what is being claimed or of what may be claimed, but rather as descriptions of features specific to particular implementations. Certain features that are described in this description in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Thus, particular implementations have been described. Other implementations are within the scope of the following claims.

What is claimed is:

1. A device for influencing the subjective perception of food or beverage to be consumed by an individual, the device comprising:
one or more items of tableware having one or more characteristics which when compared to a portion of food or beverage combined with the tableware alters the subjective perception of the quantity of food or beverage to be consumed.

2. The device of claim 1, wherein the tableware is one or more of a dinner plate, a soup bowl, a glass, and a utensil.

3. The device of claim 1, wherein the characteristic is a size of the tableware and the subjective perception of the quantity of food or beverage is altered by regulation of the size of the tableware.

4. The device of claim 1, wherein the characteristic is one of a graphic design, color, shape, or weight of the tableware and the subjective perception of the quantity of food or beverage is altered based on the characteristic.

5. The device of claim 2, wherein the dinner plate has a diameter of about 9 inches to about 11 inches, the soup bowl is less than or equal to 12 ounces, the glass is less than or equal to 10 ounces, and the utensil is less than or equal to 2 ounces.

6. The device of claim 4, wherein the graphic design characteristics include one or more of verge lines, rim designs, contrasting colors, textures, and finishes.

7. A method of reducing food intake, the method comprising providing tableware having one or more characteristics designed to influence the subjective perception of the amount of food or beverage to be consumed by an individual.

8. The method of claim 7, wherein providing tableware comprises providing one or more of a dinner plate, a soup bowl, a glass, and a utensil.

9. The method of claim 7, wherein the one or more characteristics is a size of the tableware and the method further comprises regulating the size of the tableware to affect the individual's perception of the amount of food or beverage contained in the tableware.

10. The method of claim 7, wherein the one or more characteristics is one of a graphic design, color, shape, or weight of the tableware and the method further comprises regulating one of the graphic design, color, shape, or weight of the tableware to affect the individual's perception of the amount of food or beverage contained in the tableware.

11. The method of claim 8, wherein the dinner plate has a diameter of about 9 inches to about 11 inches, the soup bowl is less than or equal to 12 ounces, the glass is less than or equal to 10 ounces, and the utensil is less than or equal to 2 ounces.

12. The method of claim 10, wherein the graphic design characteristics include one or more of verge lines, rim designs, contrasting colors, textures, and finishes.

13. A dishware system comprising:
a first plate having a first outer diameter;
a second plate having a second outer diameter, a ratio of the second outer diameter to the first outer diameter being about three-to-four;
a third plate having a third outer diameter, a ratio of the third outer diameter to the first outer diameter being about two-to-three; and
a first bowl having a fourth outer diameter, a ratio of the fourth outer diameter to the first outer diameter being about two-to-three, wherein the first, second, third, and fourth outer diameters being proportionally sized to regulate the amount of food consumed by a user of the dishware system.

14. The dishware system of claim 13, wherein the food intake reduction is in the range of about ten to thirty percent.

15. The dishware system of claim 13, wherein the first outer diameter is within a range of about nine inches to about eleven inches.

16. The dishware system of claim 13, further comprising:
a first beverage container having a first height, a fifth outer diameter, and a first volume, a ratio of the first height to the fifth outer diameter being about two to one and the first volume being in a range of about eight to about ten ounces.

17. The dishware system of claim 16, further comprising:
a second beverage container having a second height, a sixth outer diameter, and a second volume, a ratio of the second height to the sixth outer diameter being about two to one and the second volume being in a range of about six ounces to about eight ounces.

18. The dishware system of claim 1, further comprising:
a placemat comprising a color that contrasts with a color of the first plate.

19. The dishware system of claim 1, further comprising:
a set of flatware comprising a fork, a knife, and a spoon, each of the fork, knife, and spoon reduced in size proportionally to the size of the first plate.

20. The dishware system of claim 13, wherein a size of one or more of the first plate, second plate, third plate, or first bowl is proportionally increased to induce a user to consume larger portions of food or proportionally decreased to induce the user to consume smaller portions of food.

21. The dishware system of claim 20, wherein the diameter of one or more of the first plate, second plate, third plate, or first bowl is proportionally increased or decreased.

22. The dishware system of claim 20, wherein a defined target area for receiving food in one or more of the first plate, second plate, third plate, or first bowl is proportionally increased to induce a user to consume larger portions of food or proportionally decreased to induce the user to consume smaller portions of food.

23. A method of regulating food intake comprising:
proportionally sizing items in a table setting, the items comprising a first plate, a first bowl, a first beverage container, and a piece of flatware, such that a user of the table setting is induced, based on the proportionality of the items in the table setting, to consume larger portions of food or smaller portions of food.

24. The method of claim 23, wherein the table setting further comprises a placemat, the placemat comprising a color that contrasts with a color of the first plate, the contrasting colors configured to affect the amount of food the user consumes.

25. The method of claim 23, wherein the first plate has a first outer diameter and the table setting further comprises a second plate having a second outer diameter, the ratio of the second outer diameter to the first outer diameter being about three-to-four, and a third plate having a third outer diameter, the ratio of the third outer diameter to the first outer diameter being about two-to-three.

26. A proportionally-sized set of dishware that aids in the regulation of food intake, the dishware comprising:
a first plate having a first outer diameter, a planar region defined in a center region of the first plate, the planar region defining a target area for receiving food, and a rim area between the planar region and an edge of the first plate;
a bowl having a second outer diameter and defining a second target area for receiving food, a ratio of the second outer diameter to the first outer diameter being about two-to-three;
a first beverage container having a height and a third outer diameter, a ratio of the height to the third outer diameter being about two to one; and
a utensil defining a food receiving area, wherein the first plate, the bowl, the first beverage container and the utensil are proportionally sized with respect to one another to increase or decrease the amount of food consumed by a user by affecting the user's perception of the amount of food or beverage present.

27. The dishware of claim 26, wherein the first plate further defines a verge line between the planar region and the rim, the verge line cooperating with the planar region and the rim to further delineate the target area for receiving food and the edge of the first plate.

28. The dishware of claim 26, further comprising a placement having a color that is different than a color of the first plate in order to enhance the user's perception of the food present on the first plate.

29. The dishware of claim 26, wherein one or more of the first plate, bowl, first beverage container, and utensil have one or more characteristics which when compared to a portion of food or beverage combined with the one or more of the first plate, bowl, beverage container and utensil alters the subjective perception of the quantity of food or beverage to be consumed.

30. The dishware of claim 29, wherein the one or more characteristics is one or more of a size, graphic design, color, shape, or weight.

31. The dishware of claim 30, wherein the graphic design characteristics include one or more of verge lines, rim designs, contrasting color, textures, and finishes.

32. A method of regulating food intake, the method comprising regulating one or more characteristics of an environment within which an individual consumes food to influence the subjective perception of the amount of food or beverage to be consumed by an individual, the one or more characteristics comprising one or more of color, lighting, sound, and temperature.
